(19) United States
(12) Patent Application Publication
(10) Pub. No.: US 2016/0006900 A1
(43) Pub. Date: Jan. 7, 2016

(54) IMAGE PROCESSING APPARATUS, METHOD FOR CONTROLLING THE SAME, AND STORAGE MEDIUM

(71) Applicant: CANON KABUSHIKI KAISHA, Tokyo (JP)

(72) Inventors: Natsuki Kato, Kawasaki-shi (JP); Daijiro Miyamoto, Kawasaki-shi (JP); Makiya Tamura, Tokyo (JP)

(21) Appl. No.: 14/788,445

(22) Filed: Jun. 30, 2015

(30) Foreign Application Priority Data
Jul. 3, 2014 (JP) 2014-138145

(51) Int. Cl. H04N 1/21

(52) U.S. Cl. CPC H04N 1/2179; H04N 2201/0094; H04N 2201/0081; H04N 2201/0039

(57) ABSTRACT

To facilitate document read setting suitable for storage folder, a method for controlling an image processing apparatus includes generating image data indicating an image of an original read by a reading unit, designating a folder to store the generated image data, acquiring a read setting corresponding to the designated folder, and reading the image of the original in accordance with the acquired read setting.

### BACKGROUND

1. Field

Aspects of the present invention generally relate to an image processing apparatus, a method for controlling the image processing apparatus, and a storage medium.

2. Description of the Related Art

A known image processing apparatus in the related art stores a file in a designated folder.

There is a known method for designating a folder as a file storage by obtaining information on folders managed hierarchically and displaying a list of the folders on a display (refer to Japanese Patent Laid-Open No. 2008-072256). The user designates a desired folder as a storage location of image data on the basis of the list of folders displayed on the display. An image processing apparatus stores the image data of the read original in the designated folder.

Hierarchically managed folders are created according to application. For example, for a system operated in a tutoring school, a folder named Student and a folder named Teacher are managed at a level lower than a root folder. The folder named Student is prepared to manage student folders. The folder named Teacher is prepared to manage teacher folders.

Furthermore, for example, folders given the names of a plurality of students are managed below the Student folder. These folders are prepared to manage documents student by student.

Furthermore, a folder for storing contracts and a folder for storing tests are managed at a level lower than the folder given the names of students.

With these folders, documents dealt in a tutoring school can be classified into files by student or the kind of document for management.

If the kinds of document stored in the folders differ, read settings suitable for the kinds of document may be performed when the documents are to be read as originals. For example, originals that are copying paper such as a contract need to be read at a density higher than usual, and originals including pictures and images, such as a personal interview material, may be read in color.

However, users have to perform document read settings irrespective of the folder in the related art.

### SUMMARY

Aspect of the present invention generally provides an image processing apparatus including a reading unit configured to read an image of an original, a generation unit configured to generate image data indicating the image of the original, a designation unit configured to designate a folder to store the generated image data, an acquisition unit configured to acquire a read setting corresponding to the designated folder, and a control unit configured to cause the reading unit to read the image of the original in accordance with the acquired read setting.

Further features of the present disclosure will become apparent from the following description of exemplary embodiments with reference to the attached drawings.

### BRIEF DESCRIPTION OF THE DRAWINGS

FIG. 1 is an overall view of an image processing system according to a first embodiment.

FIG. 2 is a block diagram showing the configuration of an MFP according to the first embodiment.

FIG. 3 is a block diagram showing the configuration of a file server according to the first embodiment.

FIG. 4 is a flowchart for explaining a control example according to the first embodiment.

FIGS. 5A and 5B are diagrams illustrating a window according to the first embodiment.

FIGS. 6A and 6B are diagrams illustrating a window according to the first embodiment.

FIGS. 7A and 7B are diagrams illustrating a window according to the first embodiment.

FIG. 8 is a flowchart for explaining a control example according to the first embodiment.

FIG. 9 is a diagram illustrating a window according to the first embodiment.

FIG. 10 is a diagram illustrating a setting file according to the first embodiment.

FIG. 11 is a diagram illustrating a window according to the first embodiment.

FIG. 12 is a flowchart for explaining a control example according to the first embodiment.

FIG. 13 is a diagram illustrating a setting file according to a second embodiment.

FIG. 14A to 14C are diagrams illustrating a window according to the second embodiment.

### DESCRIPTION OF THE EMBODIMENTS

Exemplary embodiments will be described in detail hereinbelow with reference to the drawings. It is to be understood that the following exemplary embodiments are not restrictive and that not all of combinations of the features described in the embodiments are absolutely necessary for the solution of the disclosure.

### First Embodiment

First, a first embodiment will be described.

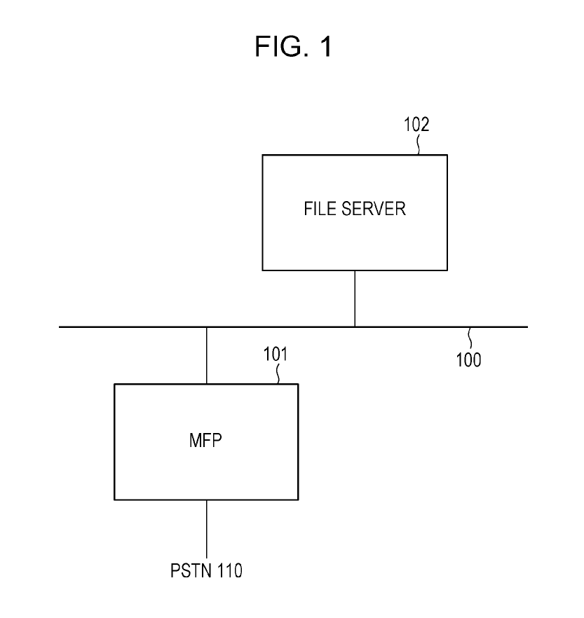

FIG. 1 is an overall view of an image processing system. A multifunction peripheral (MFP) 101 and a file server 102 are connected over a network (LAN: local area network) 100 so as to communicate with each other. The MFP 101 is given as an example of the image processing apparatus, and any other apparatuses having the function of naming files can be used, such as a PC and a mobile terminal.

The file server 102 is an example of an external device. Although the image processing system of this embodiment includes the MFP 101 and the file server 102, only the MFP 101 can be referred to as an image processing system. The MFP 101 is also connected to a public switched telephone networks (PSTN) 110, allowing image data to be sent and received to/from a facsimile machine (not shown).

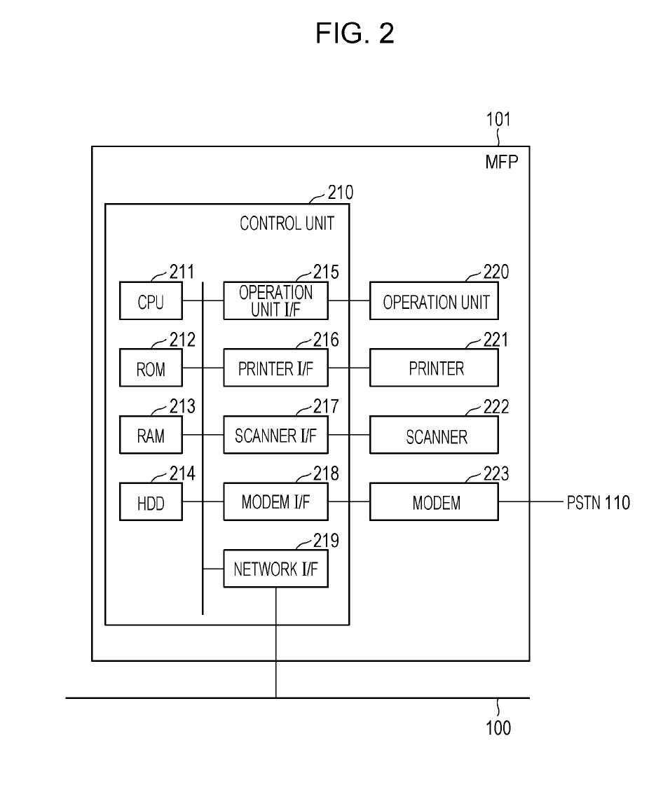

FIG. 2 is a hardware configuration diagram of the MFP 101.

A control unit 210 including a CPU 211 controls the overall operation of the MFP 101.

The CPU 211 reads control programs stored in a ROM 212 and controls reading, printing, communications, and so on.

A RAM 213 is used as a temporary storage area, such as a main memory or a working area for the CPU 211. Although the MFP 101 is configured such that one CPU 211 executes various processes shown in the following flowchart using one memory (the RAM 213 or a HDD 214), another configuration may be employed. For example, a plurality of CPUs and a plurality of RAMs or HDDs may cooperate to execute the processes shown in the flowchart.

The HDD 214 stores image data and various programs. An operation unit I/F 215 connects an operation unit 220 and the control unit 210. The operation unit 220 includes a liquid crystal display having a touch-panel function and a keyboard and acts as a receiving unit that receives an operation, an input, and an instruction from a user.

A printer I/F 216 connects a printer 221 and the control unit 210. Image data to be printed by the printer 221 is transferred from the control unit 210 via the printer I/F 216 and is printed on a recording medium by the printer 221.

A scanner I/F 217 connects a scanner 222 and the control unit 210. The scanner 222 reads an image on an original, generates image data, and inputs the image data to the control unit 210 via the scanner I/F 217. The MFP 101 can convert the image data generated by the scanner 222 to a file and thereafter transmit the file to the file server 102 on the basis of the Web-based distributed authoring and versioning (WebDAV) protocol. Conversion to a file is generation of a file including image data, and any file formats may be employed, such as a portable document format (PDF) and a tagged image file format (TIFF). Filed image data is hereinafter referred to as an image file. In place of the WebDAV, a file transfer protocol (FTP) or a server message block (SMB) may be used.

A modem I/F 218 connects a modem 223 and the control unit 210. The modem 223 executes facsimile communications of image data with a facsimile machine (not shown). A network I/F 219 connects the control unit 210 (MFP 101) to a LAN 100. The MFP 101 transmits image files and information to an external device (the file server 102 or the like) on the LAN 100 and receives various items of information therefrom via the network I/F 219.

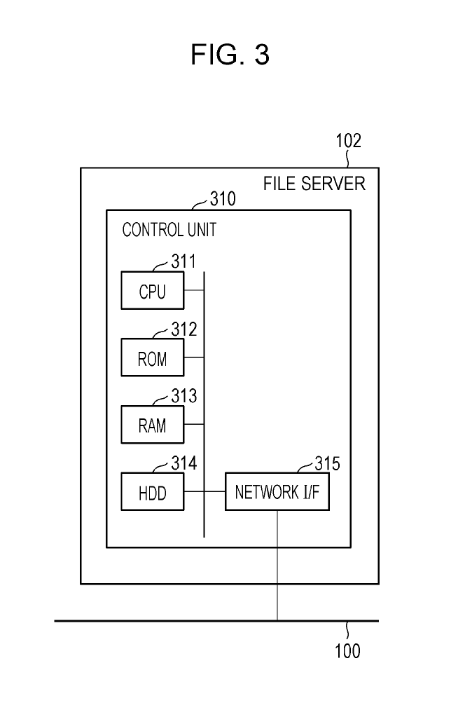

FIG. 3 is a hardware configuration diagram of the file server 102. A control unit 310 including a CPU 311 controls the overall operation of the file server 102. The CPU 311 reads control programs stored in a ROM 312 and executes various control operations. A RAM 313 is used as a temporary storage area, such as a main memory or a working area for the CPU 311. A HDD 314 stores image data and various programs. The HDD 314 has a plurality of folders that are hierarchically managed, in which image files transmitted from the MFP 101 can be stored. The image files stored in the folders can be viewed and operated from a PC (not shown) on the LAN 100.

A network I/F 315 connects the control unit 310 (the file server 102) to the LAN 100. The file server 102 transmits and receives various pieces of information to/from another device on the LAN 100 via the network I/F 315.

Next, the operation of the image processing system (services provided using the image processing system) will be described using an example of a tutoring-school support system. The tutoring-school support system is a system for increasing the efficiency of the operations of tutoring schools in which a large volume of documents printed on paper are handled to facilitate the operations of reading the documents with a scanner and uploading them to a file server. The tutoring-school support system is implemented using an application named [Tutoring-school filing] installed in the MFP 101 and a file system in the file server 102, which hierarchically manages a plurality of folders.

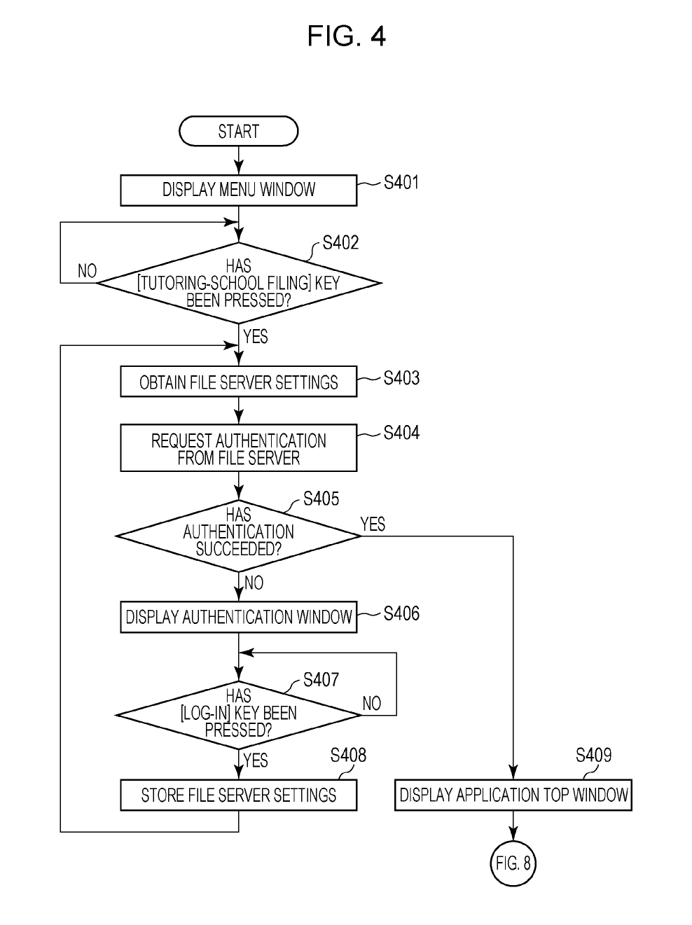

FIG. 4 is a flowchart explaining operations from the start of the MFP 101 until a top window 610 of the application [Tutoring-school filing] is displayed. The operations (steps) shown in the flowchart in FIG. 4 are implemented by the CPU 211 of the MFP 101 executing a control program stored in the HDD 214.

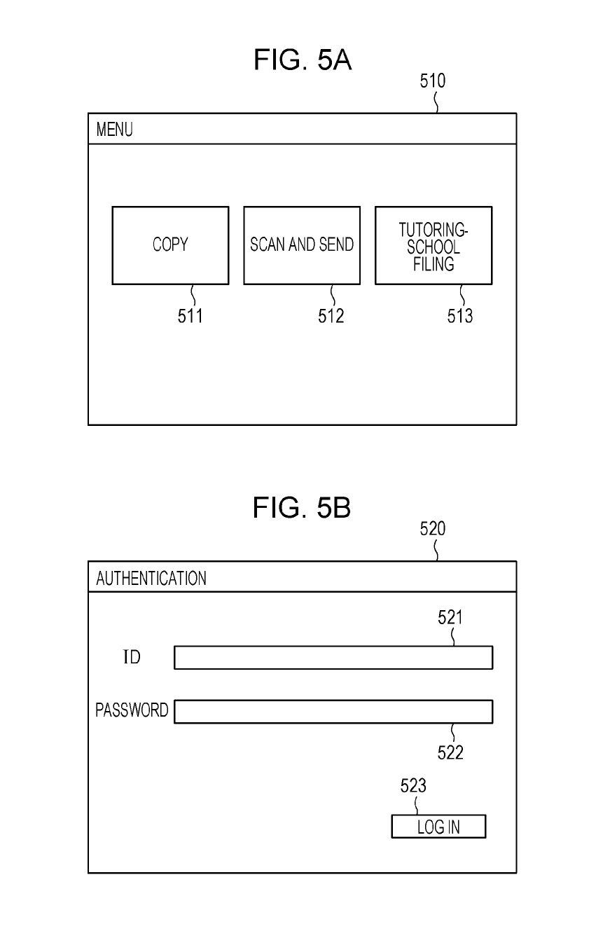

At S401, the CPU 211 displays a menu window 510 shown in FIG. 5A on the operation unit 220. The menu window 510 displays a list of the functions and applications of the MFP 101. A [Copy] key 511 and a [Scan and send] key 512 shown in FIG. 5A are operation keys corresponding to standard functions of the MFP 101 (native functions). A [Tutoring-school filing] key 513 is an operation key corresponding to a Java® based application that is additionally installed in the MFP 101. The MFP 101 may have other native functions (not shown) and other applications.

At S402, the CPU 211 determines whether the [Tutoring-school filing] key 513 has been pressed. When the [Tutoring-school filing] key 513 is pressed, the program goes to step S403, and when it is not pressed, the program waits until it is pressed. When the [Copy] key 511 or the [Scan and send] key 512 is pressed, a function corresponding to it is executed.

At S403, the CPU 211 obtains file server settings stored in the HDD 214. The file server settings are in the form of a file in a CSV or an XML format including information on the file server 102. The file server settings include the host name of the file server 102 and information in a root folder that is the starting point of the folder path. The file server settings further include authentication information (ID and a password) for logging in the file server 102. The information included in the file server settings needs to be input in advance by the administrator or the user of the MFP 101 via a file server settings window displayed on a PC (not shown).

At S404, the CPU 211 requests authentication from the file server 102 on the basis of the file server settings obtained at S403. If the authentication succeeds, the MFP 101 is permitted to access the file server 102.

At S405, the CPU 211 determines whether the authentication at the file server 102 has succeeded to permit logging-in. If the authentication has succeeded, the program goes to S409, and if the authentication has failed, the program goes to S406.

At S406, the CPU 211 causes the operation unit 220 to display an authentication window 520 shown in FIG. 5B. If the authentication at the file server 102 has failed, the authentication information in the file server settings can have an error, and the CPU 211 prompts the user to input authentication information via the authentication window 520. At step S407, it is determined whether a [log-in] key 523 has been pressed. If the [log-in] key 523 has been pressed, then the program goes to S408, and if it has not been pressed, the program waits until it is pressed.

At S408, the CPU 211 stores the authentication information input by the user in the HDD 214 and returns to S403. Performing the process in S408 eliminates the need for the user to input authentication information at the next and subsequent log-in operations; however, the program may go to S404 without performing the processes at S408 and S403. Alternatively, after the CPU 211 moves to S404 without performing the processes at S408 and S403 and determines at S405 that authentication has succeeded, the authentication information may be stored.

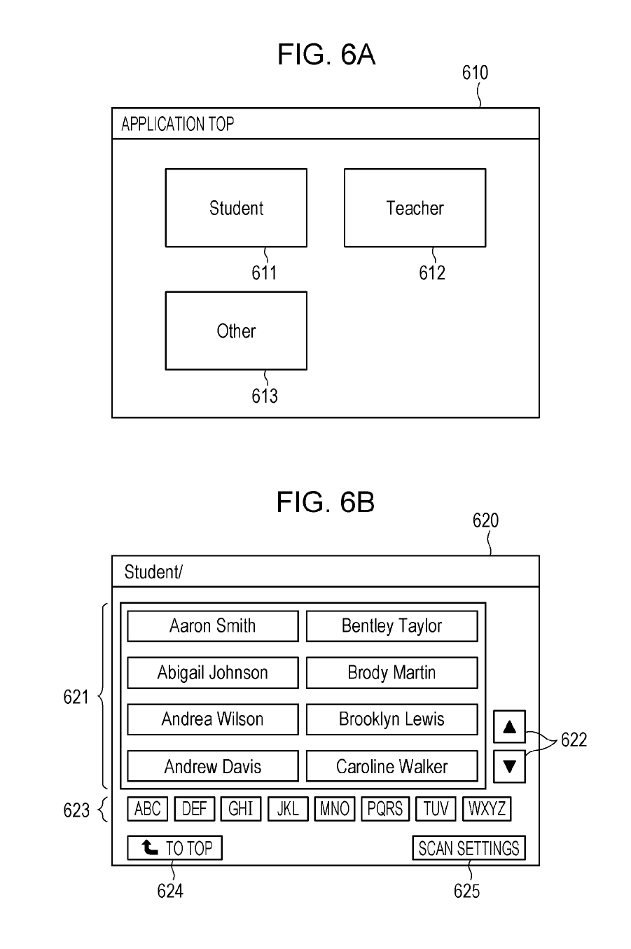

At S409, the CPU 211 displays an application top window 610 shown in FIG. 6A on the operation unit 220. The application top window 610 displays a [Student] key 611, a [Teacher] key 612, and an [Other] key 613. In the tutoring-school support system, a folder named [Student], a folder named [Teacher] and a folder named [Other] are created directly under the root folder. To display the application top window 610, the MFP 101 obtains information on folders directly under the root folder from the file server 102. The MFP 101 displays the [Student] key 611, the [Teacher] key 612, and the [Other] key 613 on the basis of the information.

When a document related to each of students enrolled in the tutoring school is to be uploaded to the file server 102, the [Student] key 611 is pressed, and when a document related to each of teachers is to be uploaded to the file server 102, the [Teacher] key 612 is pressed. When another document is to be uploaded to the file server 102, the [Other] key 613 is pressed.

When the [Student] key 611 is pressed, a student list window 620 shown in FIG. 6B is displayed on the operation unit 220. An area 621 displays a list of the names of students enrolled in the tutoring-school support system. Subfolders of students in which the names of the students are set as folder names are created directly under the {Student} folder. To display the student list window 620, the MFP 101 obtains information of the folders directly under the [Student] folder from the file server 102 and displays the area 621 on the basis of the information. Student folders can be newly created or deleted by an operation from a PC (not shown). The student folders are sorted in alphabetical order and displayed by the MFP 101.

Scroll keys 622 are operation keys for displaying student names that are not displayed in the area 621 on the area 621 (for scrolling the window). An index key 623 is an operation key for specifying the initial letter of a target student name and displaying the name of the student in the area 621. A [To top] key 624 is an operation key for displaying folders one level higher. When the [To top] key 624 is pressed, the application top window 610 is displayed. A [Scan settings] key 625 is an operation key for displaying a scan settings window, described below. When the scan settings window is displayed using the [Scan settings] key 625, an image file created using the scanner 222 is stored in the [Student] folder.

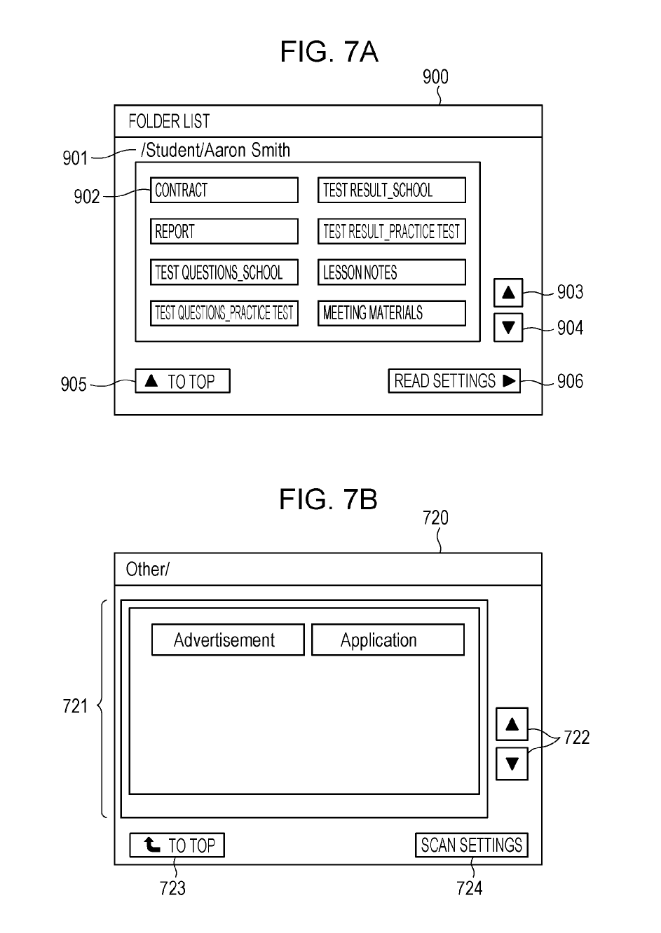

When one of the operation keys in the area 621 is pressed, a document-type list window 710 shown in FIG. 7A is displayed. FIG. 7A shows a case in which a student named [Aaron Smith] (a folder named ([Aaron Smith]) is selected. An area 901 shows that a folder stored in the [Aaron Smith] folder under the [Student] folder is displayed in an area 902.

The area 902 displays a list of document types registered in the tutoring-school support system. Subfolders in which the names of document types are set as folder names are created directly under the [Aaron Smith] folder. In the example of FIG. 7A, subfolders, such as [Contract], [Report], and [Test questions school], are stored in the area 902. Such folders are created also directly under the folders of the other students.

To display a folder list window 900, the MFP 101 obtains information of the folders directly under the [Aaron Smith] folder from the file server 102 and displays the area 902 on the basis of the information. Type folders can be newly created or deleted by an operation from a PC (not shown).

Scroll keys 903 and 904 are operation keys for displaying document types that are not displayed in the area 902 on the area 902 (for scrolling the window). A [To top] key 905 is an operation key for displaying folders one level higher. When the [To top] key 905 is pressed, the student list window 620 is displayed. A [Read settings] key 906 is an operation key for displaying the scan settings window described below. When the scan settings window is displayed using the [Read settings] key 906, and a read instruction is accepted by accepting scan settings, an image file generated using the scanner 222 is stored in the [Aaron Smith] folder.

When the [Other] key 613 is pressed in the application top window in FIG. 6A, a document-type list window 720 shown in FIG. 7B is displayed. An area 721 displays a list of document types registered in the tutoring-school support system. Subfolders in which the names of document types are set as folder names are created directly under an [other] folder. To display the document-type list window 720, the MFP 101 obtains information of the folders directly under the [other] folder from the file server 102 and displays the area 721 on the basis of this information. Type folders can be newly created or deleted by an operation from a PC (not shown).

Scroll keys 722 are operation keys for displaying document types that are not displayed in the area 721 on the area 721 (for scrolling the window). Since only two folders are present directly under the [other] folder, all of them are displayed on the window shown in FIG. 7B. If seven or more folders are present, not all the folders can be displayed, so that the scroll keys 722 are used. A [To top] key 723 is an operation key for displaying folders one level higher. When the [To top] key 723 is pressed, the application top window 610 is displayed. A [Scan settings] key 724 is an operation key for displaying the scan settings window described below. When the scan settings window is displayed using the [Scan settings] key 724, an image file generated using the scanner 222 is stored in the [other] folder.

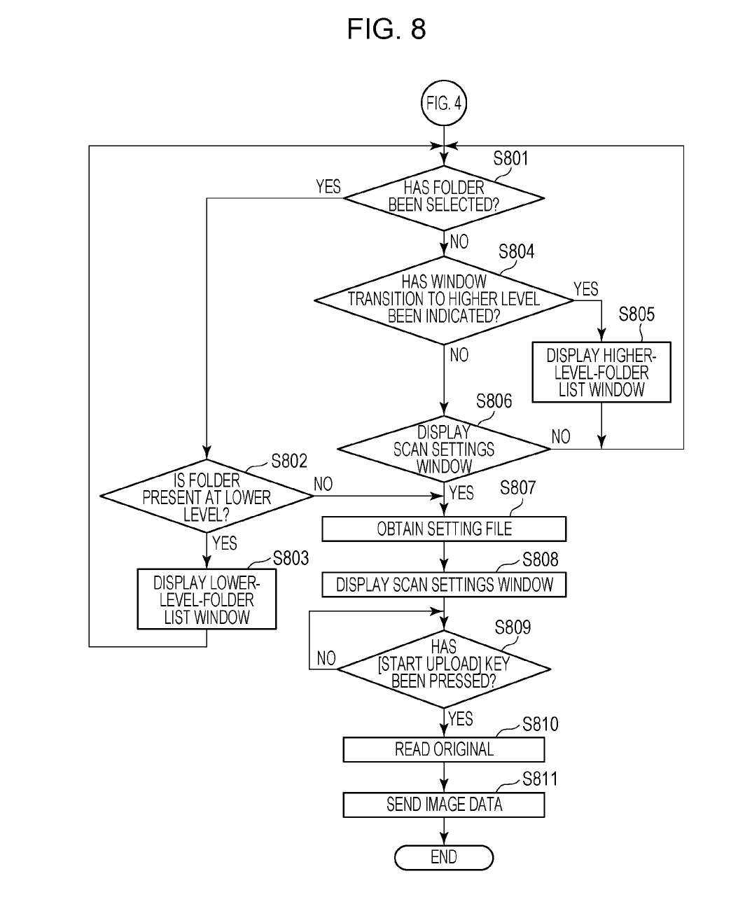

FIG. 8 is a flowchart explaining the operations of the MFP 101 including window transition after the application top window 610 is displayed. The operations (steps) shown in the flowchart of FIG. 8 are implemented by the CPU 211 of the MFP 101 executing a control program stored in the HDD 214.

At S801, it is determined whether a folder is selected by the user. When the [Student] key 611, the [Teacher] key 612, the [Other] key 613, or one of operation keys in the areas 621, 902, and 721 is pressed, the CPU 211 determines that a folder is selected by the user and goes to S802.

At S802, the CPU 211 determines whether the folder selected at S801 is a folder having subfolders. This determination is performed by inquiring from the file server 102 about whether subfolders are present. When the [Student] key 611, the [Teacher] key 612, the [Other] key 613, or one of the operation keys in the area 621 is pressed, the CPU 211 determines that the selected folder is a folder having subfolders and goes to S803. When one of the operation keys in the area 902 or one of the operation keys in the area 721 is pressed, the CPU 211 determines that the selected folder is not a folder having subfolders and goes to S807. Note that even if a file is placed directly under the selected folder, it is determined that the folder has no subfolder unless a folder is present.

At S803, a list of folders directly under the folder selected at S801 (folders one level lower than the folder selected at S801) is displayed. Specifically, S803 corresponds to a window transition from FIG. 6A to FIG. 6B or FIG. 7B or a window transition from FIG. 6B to FIG. 7A.

At S804, it is determined whether an instruction to transit to a higher layer is given. If one of the [To top] keys 624, 905, and 723 is pressed, the CPU 211 determines that an instruction to transit to a higher layer is given and goes to S805. At S805, a list of folders one level higher than the currently displayed layer is displayed. Specifically, S805 corresponds to a window transition from FIG. 6B or FIG. 7B to FIG. 6A or a window transition from FIG. 7A to FIG. 6B.

At S806, it is determined whether an instruction to display a scan settings window is given. If one of the [Read settings] keys 625, 906, and 724 is pressed, the CPU 211 determines that an instruction to display a scan settings window is given and goes to step S807.

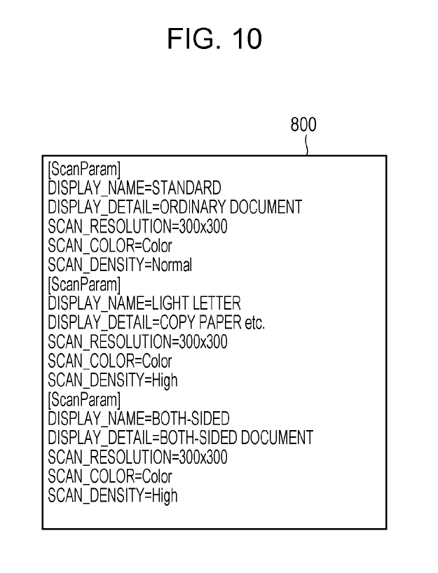

At S807, a setting file stored in a folder corresponding to a window displayed when the [Read settings] key is pressed is obtained. If the selected folder is a folder at the lowest level (No at S802), the CPU 211 obtains the setting file from the lowest-level folder. Specifically, if the [Read settings] key 625 in the window shown in FIG. 6B is pressed, a setting file stored in the [Student] folder is obtained. If the [Read settings] key 906 in the window shown in FIG. 7A is pressed, a setting file stored in the [Aaron Smith] folder is obtained. If the [Read settings] key 724 in the window shown in FIG. 7B is pressed, a setting file stored in the [other] folder is obtained. FIG. 10 shows an example of the setting files. If the [Contract] folder in FIG. 7A is selected, the CPU 211 obtains a setting file from the [Contract] folder.

FIG. 10 is a setting file example 800 in which various read settings are recorded. [ScanParam] at the top indicates that a description about new read settings starts from this row. In the setting file 800, a plurality of read settings recorded in one [ScanParam] are dealt as a read setting group.

DISPLAY_NAME indicates the name of the read setting.

DISPLAY_DETAIL indicates the detail of the read setting.

SCAN_RESOLUTION indicates a setting on reading resolution.

SCAN_COLOR indicates a setting on whether reading is to be performed in color or monochrome.

SCAN_DENSITY indicates a setting on reading density.

It is to be understood that these items are mere examples and each setting file may include other items and that reading parameters other than those in FIG. 10 may be set in the individual items. Furthermore, default settings may be used for items not recorded.

Such a setting file is prepared for each folder, and the user can define read setting parameters suitable for the application of each folder in advance.

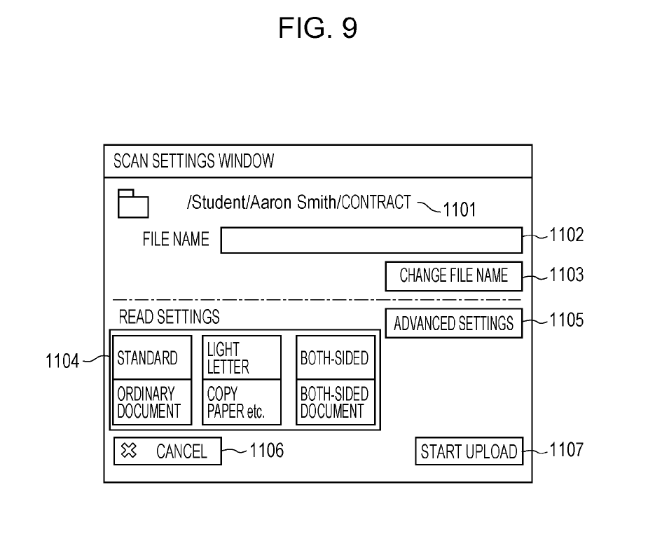

At S808, the CPU 211 displays the scan settings window shown in FIG. 9 on the operation unit 220 in accordance with read settings recorded in the setting file obtained at S807. The user performs read settings and a setting on the file name of a file to be sent via the scan settings window.

FIG. 9 is a window that is displayed when a folder named [Contract] prepared under the [Aaron Smith] folder under the [Student] folder is selected on the window in FIG. 7A. Since there is no folder under [Contract], the process is moved from S802 to S807, in which a setting file stored in the [Contract] folder is obtained.

An area 1101 displays folder path information indicating the storage location of an image file generated using the scanner 222. The folder path information indicates a relative path relative to the root folder (hierarchically lower than the root folder). The example shown in FIG. 9 shows that the [Contract] folder is selected as the storage location of the image file.

A [File name] area 1102 is an area in which a currently set file name is displayed. A [Change file name] key 1103 is an operation key for changing the file name of the image file. When the [Change file name] key 1103 is pressed, a software keyboard or the like for changing the file name is displayed.

Read setting selection buttons 1104 are buttons displayed on the basis of the read setting group recorded on the setting file obtained at S807. The character strings defined by DISPLAY_NAME in FIG. 10 are displayed at the upper parts of the individual buttons, and the character strings defined by DISPLAY_DETAIL in FIG. 10 are displayed at the lower parts of the individual buttons.

When one button is selected, a read setting group recorded on [ScanParam] corresponding to the button is selected. When a [Start upload] key 1107 is pressed at S809 in a state in which one button is selected, the CPU 211 advances the process to S810. At S810, the CPU 211 causes the scanner 222 to read the image of the original in accordance with the selected read setting group. At S811, the CPU 211 converts the image data indicating the image of the read original to a file and sends the file to a designated folder. In contrast, a cancel button 1106 is pressed in the scan settings window shown in FIG. 9, the items set in the scan settings window are cancelled and the windows shifts to the preceding window.

In this embodiment, three items of [ScanParam] are recorded in the setting file 800, and buttons corresponding to all the items of [ScanParam] can be displayed. In the case where so many items of [ScanParam] are recorded in the setting file 800 that all the buttons cannot be displayed, a scroll key may be displayed so that buttons that cannot be displayed can be displayed when the scroll key is pressed. The number of buttons may be changed depending on the number of items of [ScanParam] recorded in the setting file 800. If the number of buttons is changed, the size and layout of the buttons may be changed.

If [ScanParam] is not defined in the setting file 800, buttons based on default read settings stored in the HDD 214 may be displayed.

The user can perform more advanced settings on the read settings selected with the selected read setting selection buttons 1104 by pressing an advanced settings button 1105.

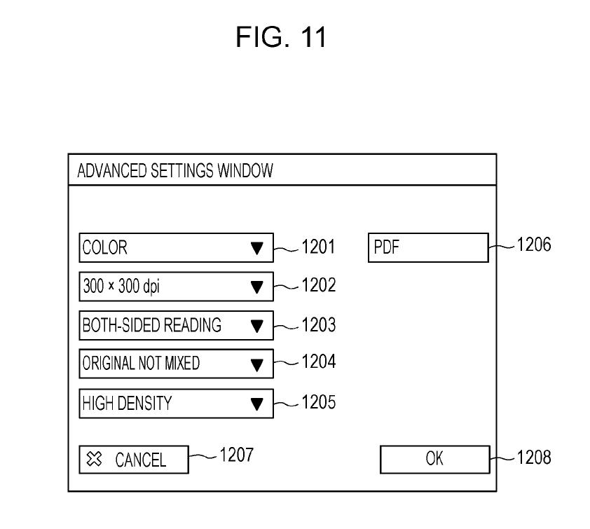

FIG. 11 shows an example of an advanced setting window displayed on the operation unit 220 when the advanced settings button 1105 is pressed.

An operation key 1201 is an operation key for setting a color mode. The user can select a desired reading color mode from the choices of [Color], [Grayscale], and [Monochrome].

An operation key 1202 is an operation key for setting a reading resolution. The user can select a desired resolution from choices, such as [300×300 dpi], [300×600 dpi], [200×200 dpi] indicated in the pull-down menu.

An operation key 1203 is an operation key for setting a single-sided reading mode or a both-sided reading mode. The user can select a desired both-sided mode from the choices of [Both-sided reading] and [Single-sided reading] indicated in the pull-down menu.

An operation key 1204 is an operation key for setting an original-mixed loading mode. The user can select a desired original-mixed loading mode from the choices of [Original mixed] and [Original not mixed] indicated in the pull-down menu.

An operation key 1205 is an operation key for setting a reading density. The user can select a desired reading density from the choices of [High density], [Normal density], and [Low density] in the pull-down menu.

An operation key 1206 is an operation key for setting a file format when the read image is to be converted to a file. The user can select a desired file format from choices, such as [TIFF], [PDF], and [PDF+high compression].

Reading parameters set with the operation keys 1201 to 1206 are stored in the RAM 213 and are read by the CPU 211 when an original is read.

When a [Cancel] key 1207 is pressed, the scan setting can be stopped, and the storage location can be changed to another folder. When an [OK] key 1208 is pressed, the CPU 211 determines the received reading parameters and causes the operation unit 220 to display the window shown in FIG. 9.

When displaying the advanced settings window shown in FIG. 11, the CPU 211 displays a window in which the setting parameters of the read setting groups corresponding to the buttons selected in FIG. 9 are reflected to the individual setting items. For the original-mixed loading mode and the file format, no setting parameters are recorded in the setting file. For such setting items, [Original not mixed] and [PDF] may be displayed as default setting parameters.

An example in which a setting file is obtained from [/Student/Aaron Smith/contract] has been described above. If a [Report] folder is selected as the storage location of the file, read settings based on a setting file stored in the [Report] folder is obtained at S807. In this case, buttons of different read setting groups are displayed by recording, in the setting file stored in the [Report] folder, read settings different from the read settings recorded in the setting file stored in the [Contract] folder. This allows the user to easily set different read settings from folder to folder. For example, for the [Contract] folder, since contracts are formed of multipart forms, a setting file including a read setting for reading documents at a density higher than usual may be stored to read copied light characters at a higher density. Thus, when the user designates the [Contract] folder as the storage location of the file, the user can easily set a density setting [High density], a reading resolution [300×300 dpi], and a color scan. In contrast, for the [Report] folder, to display the read document in detail, a setting file including a read setting for reading the document at 300×600 dpi may be stored. Thus, when the user designates the [report] folder as the storage location of the file, the user can easily set a density setting [High density], a reading resolution [300×600 dpi], and a color scan. The [Student] folder can store a setting file including a read setting for reading an original at both sides. The [Teacher] folder can store a setting file including a read setting for reading an original at a single side. Thus, the user can easily set read settings suitable for a document to be stored in a folder.

With this embodiment, a setting file in which read settings are recorded for each folder is prepared, and when a scan settings window is to be displayed, read settings suitable for a folder designated as the storage location of the file can easily be set, and the original can be read using the set read settings.

Although the above embodiment has been described using an example in which the setting file does not include a file format, the setting file may include the file format. For example, the file format may include [TIFF], [PDF], and [PDF+high compression]. When a file format is recorded, the CPU 211 converts the image data on the read original to a file according to the file format recorded in the setting file.

Although this embodiment has been described using an example in which a plurality of setting files are stored in a folder, and the user selects one of the plurality of setting files, this embodiment is not seen to be restrictive. For example, if one setting file is stored in a folder, and the folder is designated as the storage location of the file, the setting file of the folder may be used without the user performing the operation of selecting a setting file. Alternatively, if one setting file is stored in a folder, and the folder is designated as the storage location of the file, the setting file of the folder may be used in accordance with the user's setting file selecting operation.

### Second Embodiment

In a second embodiment, an example in which the form of a display screen is recorded in a setting file will be described. Since the configuration and basic control of the system are the same as those of the first embodiment, differences from the first embodiment will be described.

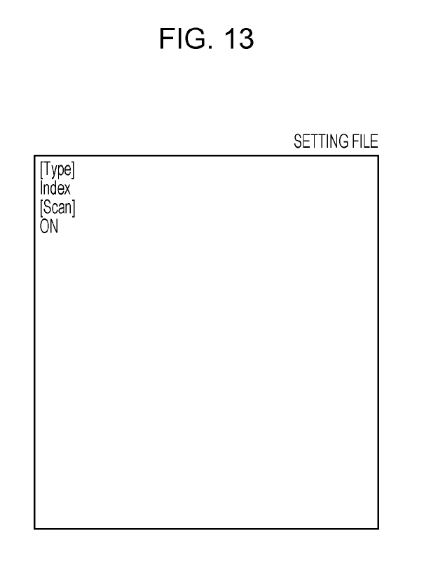

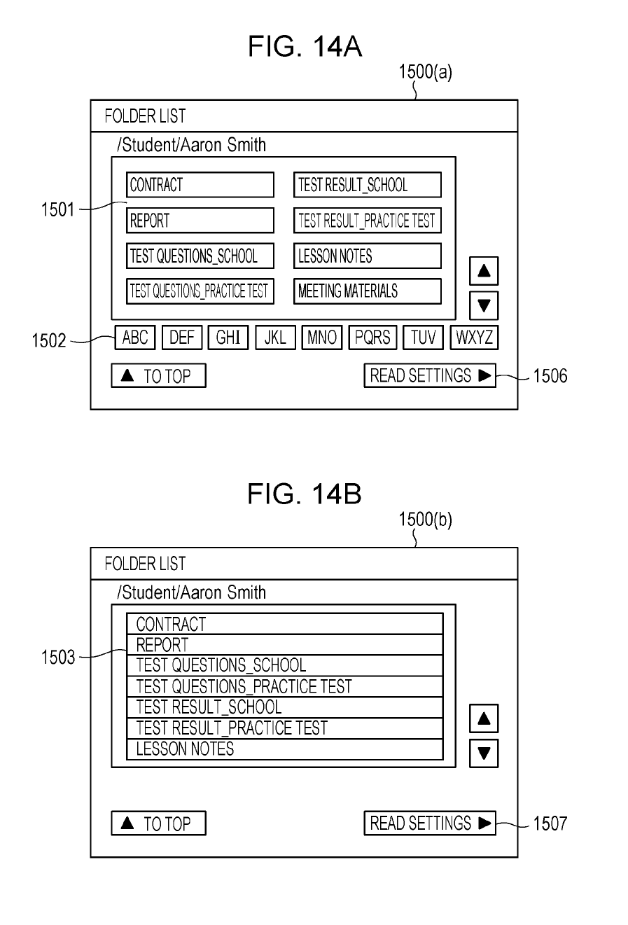

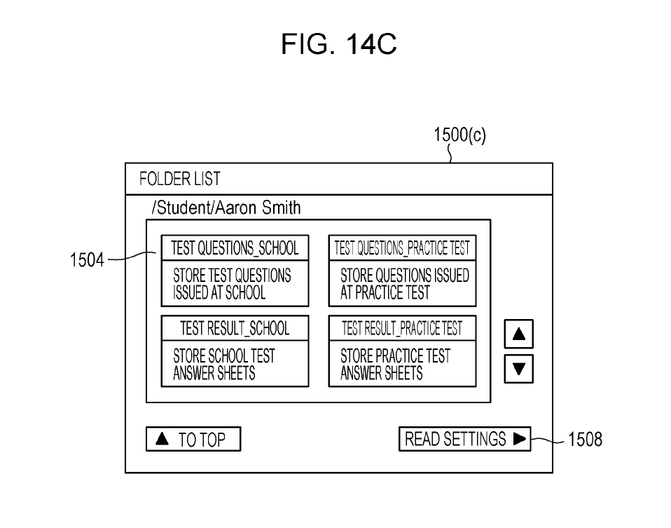

FIG. 13 is an example of the setting file in which the form of the display screen is recorded.

[Type] describes a display type for displaying a list window. Here, Index for displaying the window in a list format is recorded. If Index is recorded, the folder display screen is displayed as in FIG. 14A. In addition to Index, List and Button are present. When List is recorded, the folder display screen is displayed as in FIG. 14B. When Button is recorded, the folder display screen is displayed as in FIG. 14C.

A folder list window 1500(a) is a display example of a window in which Index is designated as a window type. An area 1501 displays a list of folders stored in the selected folder. In the example shown in FIG. 14A, a list of folders is stored in a folder [/Student/Aaron Smith]. Alphabet keys 1502 are for entering the spelling of the folders displayed in the area 1501. If a “C” button is pressed, the area 1501 displays folders having folder names beginning with “C” in alphabetical order.

A folder list window 1500(b) is a display example of a window in which List is designated as a window type. An area 1503 displays folders stored in the selected folder one above the other in a list format. Although this is an example in which seven folders are displayed at a time, the number of rows displayed at a time may be changed depending on the screen size. The number of rows to be displayed at a time may be recorded in the setting file, and folders may be displayed depending on the number of rows recorded in the setting file.

A folder list window 1500(c) is a display example of a window in which Button is designated as a window type. An area 1504 displays folders stored in the selected folder in the form of buttons in which folder names and descriptions of the folders are described. Here, four buttons are displayed at a time; however, the number of buttons displayed at a time may be changed depending on the screen size. The number buttons to be displayed at a time may be recorded in the setting file, and buttons may be displayed depending on the number of rows recorded in the setting file. The names and descriptions of the folders may be recorded in the setting file, and the CPU 211 may obtains them for display.

[Scan] indicates whether the file can be stored in the selected folder. If [Scan] is ON, the file can be stored in the selected folder, and if [Scan] is OFF, the file cannot be stored in the selected folder.

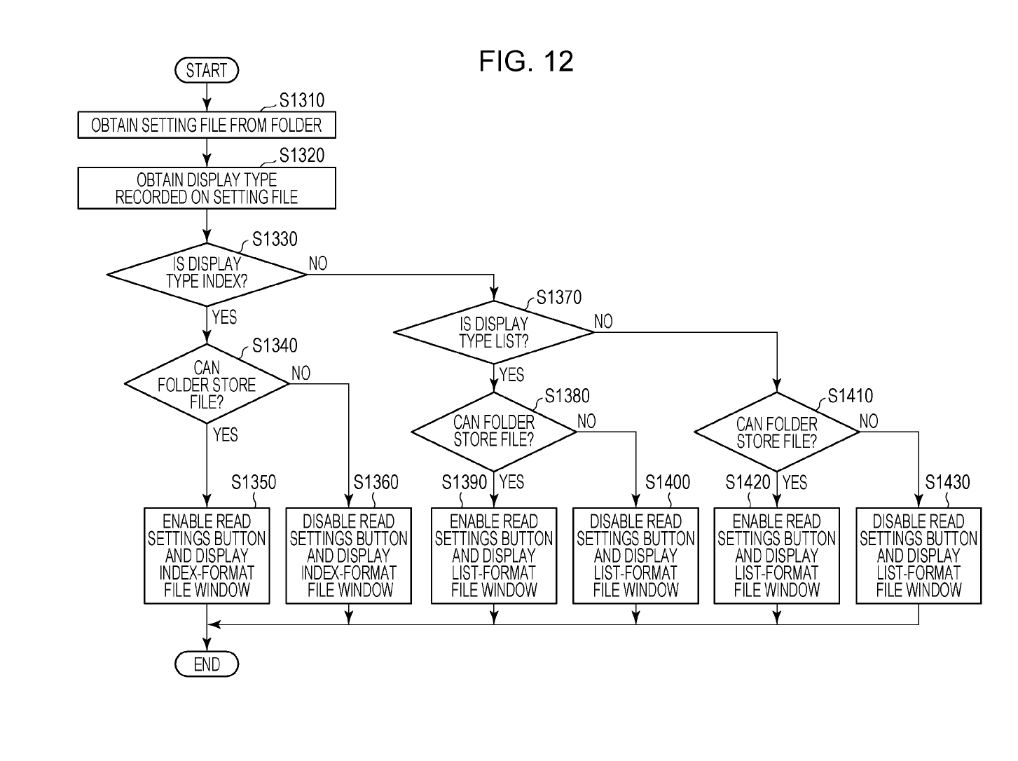

FIG. 12 is a flowchart for the operation of the MFP 101 to display a folder list window. The operations in the flowchart of FIG. 12 are performed when a folder list window is displayed at S803 and S805 in FIG. 8. The operations (steps) shown in the flowchart of FIG. 13 are implemented by the CPU 211 of the MFP 101 executing a control program stored in the HDD 214.

At S1310, the CPU 211 obtains a setting file prepared at the same level of hierarchy as that of folders displayed in the list window.

At S1320, the CPU 211 obtains a display type recorded in the setting file. That is, the CPU 211 obtains the display type recorded in [Type] in FIG. 13.

At S1330, the CPU 211 determines whether the display type obtained at S1320 is Index. If the CPU 211 determines that the display type obtained at S1320 is Index, the CPU 211 advances the process to S1340, and if the CPU 211 determines that the display type obtained at S1320 is not Index, the CPU 211 advances the process to S1370.

At S1340, the CPU 211 determines whether the folder can store the file on the basis of information recorded in [Scan] in the setting file. If [Scan] is ON, the CPU 211 determines that the folder can store the file and advances the process to S1350, and if [Scan] is OFF, the CPU 211 determines that the folder cannot store the file and advances the process to S1360.

At S1350, the CPU 211 causes the operation unit 220 to display folders to be displayed on a list window in the Index format shown in FIG. 14A. The CPU 211 enables a read settings button 1506 to enable the file to be stored in the folder.

At S1360, the CPU 211 causes the operation unit 220 to display folders to be displayed on a list window in the Index format shown in FIG. 14A. The CPU 211 disables the read settings button 1506 to disable storage of the file in the folder.

If the process is advanced from S1330 to S1370, the CPU 211 determines whether the display type obtained at S1320 is List. If the CPU 211 determines that the display type obtained at S1320 is List, the CPU 211 advances the process to S1380, and if the CPU 211 determines that the display type obtained at S1320 is not List, the CPU 211 advances the process to S1410.

At S1380, the CPU 211 determines whether the folder can store the file on the basis of the information recorded in [Scan] in the setting file. If [Scan] is ON, the CPU 211 determines that the folder can store the file and advances the process to S1390, and if [Scan] is OFF, the CPU 211 determines that the folder cannot store the file and advances the process to S1400.

At S1390, the CPU 211 causes the operation unit 220 to display folders to be displayed on a list window in the List format shown in FIG. 14B. The CPU 211 enables a read settings button 1507 to enable the file to be stored in the folder.

At S1400, the CPU 211 causes the operation unit 220 to display folders to be displayed on a list window in the List format shown in FIG. 14B. The CPU 211 disables the read settings button 1507 to disable storage of the file into the folder.

If the process is advanced from S1370 to S1410, the display type obtained at S1320 is Button.

At S1410, the CPU 211 determines whether the folder can store the file on the basis of the information recorded in [Scan] in the setting file. If [Scan] is ON, the CPU 211 determines that the folder can store the file and advances the process to S1420, and if [Scan] is OFF, the CPU 211 determines that the folder cannot store the file and advances the process to S1430.

At S1420, the CPU 211 causes the operation unit 220 to display folders to be displayed on a list window in the Button format shown in FIG. 14C. The CPU 211 enables a read settings button 1508 to enable the file to be stored in the folder.

At S1430, the CPU 211 causes the operation unit 220 to display folders to be displayed on a list window in the Button format shown in FIG. 14C. The CPU 211 disables the read settings button 1508 to disable storage of the file into the folder.

With this embodiment, a list of folders in an easy-to-view display format can be displayed for each folder. Furthermore, recording folders that are not to store files in a setting file in advance prevents storage of files in the folder.

The setting file of the second embodiment may include the read settings described in the first embodiment. In this case, when a read settings button is pressed, a window as shown in FIG. 9 may be displayed in accordance with the control described in the first embodiment.

Although the second embodiment shows three display types as examples, other display types may be defined in the setting file. The way of setting the display type of the window stored in the setting file is not limited to that shown in FIG. 13; another way of setting may be employed provided that it can be understood by the CPU 211.

### Other Embodiments

Although the above embodiments show an example in which the MFP 101 and the file server 102 are separate objects, the MFP 101 may incorporate the function of the file server 102. Embodiments can also be realized by a computer of a system or apparatus that reads out and executes computer executable instructions recorded on a storage medium (e.g., computer-readable storage medium) to perform the functions of one or more of the above-described embodiment(s), and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™, a flash memory device, a memory card, and the like.

While the present disclosure has been described with reference to exemplary embodiments, it is to be understood that these exemplary embodiments are not seen to be restrictive. The scope of the following claims is to be accorded the broadest interpretation so as to encompass all such modifications and equivalent structures and functions.

This application claims the benefit of Japanese Patent Application No. 2014-138145, filed Jul. 3, 2014, which is hereby incorporated by reference herein in its entirety.

What is claimed is:

1. An image processing apparatus comprising:
a reading unit configured to read an image of an original;
a generation unit configured to generate image data indicating the image of the original;
a designation unit configured to designate a folder to store the generated image data;
an acquisition unit configured to acquire a read setting corresponding to the designated folder; and
a control unit configured to cause the reading unit to read the image of the original in accordance with the acquired read setting.

2. The image processing apparatus according to claim 1, wherein the acquisition unit obtains a read setting corresponding to the designated folder from the designated folder.

3. The image processing apparatus according to claim 1, wherein
the acquisition unit obtains a plurality of read settings corresponding to the designated folder; and
the control unit causes the reading unit to read the image of the original in accordance with a read setting selected by a user from the acquired read settings.

4. The image processing apparatus according to claim 1 further comprising:
a specification unit configured to specify a file format corresponding to the designated folder; and
a conversion unit configured to convert the generated image data to a file in the specified file format.

5. The image processing apparatus according to claim 1, further comprising a storage unit configured to store the generated image data in the designated folder.

6. The image processing apparatus according to claim 1, further comprising:
a determination unit configured to determine whether the designated folder is a folder that can store a file; and
a disabling unit configured to disable storage of a file in the designated folder when the determination unit determines that the designated folder cannot store the file.

7. The image processing apparatus according to claim 1, wherein when the read setting cannot be obtained, the control unit causes the reading unit to read the image of the original in accordance with a stored read setting.

8. A method for controlling an image processing apparatus, the method comprising:
generating image data indicating an image of an original read by a reading unit;
designating a folder to store the generated image data;
acquiring a read setting corresponding to the designated folder; and
reading the image of the original in accordance with the acquired read setting.

9. A computer-readable storage medium storing computer executable instructions for causing a computer to execute a method for controlling an image processing apparatus, the method comprising:
generating image data indicating an image of an original read by a reading unit;
designating a folder to store the generated image data;
acquiring a read setting corresponding to the designated folder; and
reading the image of the original in accordance with the acquired read setting.
